(19) United States
(12) Patent Application Publication
(10) Pub. No.: US 2013/0200172 A1
(43) Pub. Date: Aug. 8, 2013

(54) PEST DETERRENT DEVICE

(71) Applicant: Opal DOWNER, Toronto (CA)

(72) Inventor: Opal DOWNER, Toronto (CA)

(21) Appl. No.: 13/571,450

(22) Filed: Aug. 10, 2012

Related U.S. Application Data
(60) Provisional application No. 61/522,519, filed on Aug. 11, 2011.

(51) Int. Cl. A01M 29/12

(52) U.S. Cl. CPC A01M 29/12
USPC 239/6; 239/57

(57) ABSTRACT

Devices and methods for deterring pests are described. In one embodiment, the device comprises a housing, a volatile deterrent agent in the housing, the volatile deterrent agent producing a pest deterrent gas, at least one outlet port in the housing for exit of the pest deterrent gas, a closure member for selectively opening and closing the at least one outlet port, and a support coupled to the housing and providing structural rigidity to the housing. In another embodiment, the method comprises providing a plurality of pest deterrent devices in an area, each pest deterrent device comprising a housing containing a volatile deterrent agent, the volatile deterrent agent producing a pest deterrent gas, and opening a closure member of each pest deterrent device to release the volatile deterrent agent.

### CROSS-REFERENCE TO RELATED APPLICATIONS

This application claims the benefit of U.S. Provisional Patent Application No. 61/522,519, filed Aug. 11, 2011, the entire contents of which are hereby incorporated by reference.

### FIELD

The disclosure relates generally to devices and methods for deterring pests, such as raccoons, from a territory.

### BACKGROUND

Canadian Patent Application No. 2,227,015 A1 (Causton) purports to disclose the use of several readily available biodegradable materials incorporated in an animal deterrent. The animal deterrent is constructed in a fashion as to be totally biodegradable. A Naphthalene moth ball is inserted into a sack and stitched closed encompassing one end of a length of twine. The unit is then suspended at variable heights and locations by whatever means available. The odour spreads throughout the area being protected and thus deters unwanted animals from invading the area.

Canadian Patent Application No. 2,223,806 A1 (Garon) purports to disclose an animal repelling device comprising a container, an offensive liquid confined in the container under pressure, and means for discharging a stream of the said offensive liquid from the container, the offensive liquid comprising a material selected from the group consisting of citronelle type materials.

International Patent Publication No. WO 2012/068484 A2 (Boyd et al.) purports to disclose methods and systems for biological control of pests and pest-borne diseases, such as in agriculture, including vapor delivery systems with a reservoir for holding a volatile compound, typically in liquid form, to be released into the atmosphere, a means of supplying the reservoir with volatile compound, one or more passive flow control nozzles attached to the reservoir, wherein each nozzle is fitted with a permeable polymeric membrane through which the volatile compound permeates and is emitted from the outer membrane surface into the atmosphere, and wherein the individual nozzles are adapted to deliver a specific predetermined release rate for each intended application, and strategic deployment of nozzles (i.e., number, location, spacing, height, etc.) to achieve performance requirements for intended applications ranging from a single plant to large fields for specific ambient conditions.

International Patent Publication No. WO 2012/071261 A1 (Lin et al.) purports to disclose compositions and articles containing a polymeric matrix and an active liquid intermixed with at least a portion of the polymeric matrix.

International Patent Publication No. WO 2012/071376 A1 (Ware et al.) purports to disclose a disposable dispenser assembly comprising an outlet channel in fluid communication with a terminal apparatus, and a pressure source providing a limited supply of fluid or gas, and also includes a collapsible liner that contains a material to be dispensed, the liner detachably secured to the dispense assembly with the outlet channel in fluid communication with an interior of the liner, wherein the material in the liner is dispensed out the liner and through the outlet channel to the terminal apparatus.

International Patent Publication No. WO 2012/048366 A1 (Gigliotti et al.) purports to disclose a chemical dosage dispenser including a reservoir containing an aerosol based chemical formulation; a bait mount on which a bait or a lure can be mounted, the bait mount being configured to be bitten by a target animal; and an activation arrangement which operatively connects the bait mount and reservoir, the activation arrangement moving between a rest position where the reservoir is closed and an activated position where the reservoir dispenses the chemical formulation.

### SUMMARY

The following summary is intended to introduce the reader to various aspects of the applicant's teaching, but not to define any invention.

The disclosure relates to a pest deterrent device. In some examples, the pest deterrent device comprises a deterrent sack. Deterrent sacks are optionally made of high-density polyethylene (HDPE) and more rigid plastics. The deterrent sacks may be transparent and visually appealing to humans. The deterrent sacks may be filled with a deterrent agent to repel pests, such as raccoons.

Deterrent sacks may be used for deterring raccoons and other pests, optionally with the use of household grade ammonia (ammonia hydroxide) functioning as a deterrent agent. Full strength industrial grade ammonia (anhydrous ammonia) may also function as a deterrent agent. Ammonia is one example of an effective deterrent agent, as is coyote urine, which may be particularly useful in repelling raccoons. Ammonia, like urine, is a volatile deterrent agent that produces an offensive odour to raccoons and other pests. Raccoons are therefore repelled by gasses produced by ammonia and predator urine. In some examples, deterrent sacks may last for an extended period of time (e.g. months). In some examples, reapplication of deterrents after rain may be unnecessary, because the device continues to function after being rained on.

Deterrent sacks are optionally transparent, and in some embodiments may be made using a relatively “soft” plastic. The use of transparent and/or soft deterrent sacks may provide a visual and tactile deterrent to raccoons, as well as the deterrent effect of the gas produced by a volatile deterrent agent (e.g. the offensive smell acting as an olfactory deterrent). In some embodiments, the relative “softness” of the plastic sacks (optionally similar to the consistency of a commercially advertised “strong” freezer bag) may also allow for the odour (i.e. a pest deterrent gas produced by the volatile deterrent agent) to be more easily detected by raccoons or other pests. Alternatively, the deterrent sacks may be made of a more rigid plastic.

In terms of look and style, deterrent sacks can be made in a variety of designs: flowers, footprints, leaves, etc.

Optional supporting frames, such as nets and/or belts, may provide a convenient way to deploy a number of deterrent sacks attached to a supporting frame over a relatively large area (e.g. roofs, lawns, etc.), and may also facilitate movement and/or easy rotation of the deterrent sacks, for example to protect lawns on which the sacks are deployed.

According to one aspect, there is provided a pest deterrent device comprising: a housing, and a volatile deterrent agent in the housing. The volatile deterrent agent produces a pest deterrent gas. At least one outlet port is in the housing for exit of the pest deterrent gas. A closure member is provided for selectively opening and closing the at least one outlet port. A support is coupled to the housing and provides structural rigidity to the housing.

In some examples, the housing comprises a flexible sack.

In some examples, the housing comprises a plastic sack, which may optionally be soft and flexible.

In some examples, the volatile deterrent agent comprises at least one of ammonia, urine, and pepper.

In some examples, the volatile deterrent agent is a solid.

In some examples, the closure member comprises at least one of a flip-cap assembly and a twist-cap assembly.

In some examples, the pest deterrent device further comprises a blocking member inhibiting liquid from entering the outlet port.

In some examples, at least a portion of the support is internal to the housing. In some examples, the housing comprises an upper surface and a lower surface, the outlet port is in the upper surface, and the support comprises a rigid tube extending between the outlet port and the lower surface. The tube may comprise a first opening in communication with the outlet port and a second opening in communication with an interior of the housing.

In some examples, the support comprises a sponge within the housing.

According to another aspect, there is provided a pest deterrent assembly comprising: a support frame, and a plurality of pest deterrent devices mounted to the support frame at a plurality of spaced apart positions. Each pest deterrent device comprises a housing, and a volatile deterrent agent in the housing. The volatile deterrent agent produces a pest deterrent gas. The housing is configured to permit the pest deterrent gas to escape therefrom.

In some examples, the flexible support frame comprises at least one of a rope and a net.

In some examples, each housing comprises a plastic sack.

In some examples, at least one of the pest deterrent devices further comprises an outlet port in the housing for exit of the pest deterrent gas, a closure member for selectively opening and closing the outlet port; and a support connected to the housing and providing structural rigidity to the housing.

In some examples, in at least one of the pest deterrent devices, the housing is fabricated from a material that is permeable to the pest deterrent gas, and impermeable to the volatile deterrent agent.

According to another aspect, there is provided a pest deterrent device comprising a generally sealed housing containing a volatile deterrent agent. The volatile deterrent agent produces a pest deterrent gas. The housing is permeable to the pest deterrent gas and impermeable to the volatile deterrent agent.

In some examples, the housing comprises a sealed plastic sack.

In some examples, the deterrent device is heat sealed and free of holes.

In some examples, the volatile deterrent agent comprises at least one of ammonia and urine.

According to another aspect, there is provided a method for deterring pests from an area comprising: providing a plurality of pest deterrent devices in the area, each pest deterrent device comprising a housing containing a volatile deterrent agent, the volatile deterrent agent producing a pest deterrent gas; and opening the closure member of each pest deterrent device to release the volatile deterrent agent.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1a is a perspective view showing an example pest deterrent device;

FIG. 1b is a perspective view of the pest deterrent device of FIG. 1a with a blocking member removed to show an outlet port;

FIG. 2a is an exploded perspective view showing a tube and outlet port assembly;

FIG. 2b is an assembled perspective view of the tube and outlet port assembly of FIG. 2a;

FIG. 3 is an exploded perspective view of the pest deterrent device of FIG. 1a showing a closure member that can be twisted to selectively allow fluid communication between the interior and exterior of the pest deterrent device;

FIG. 4a is a perspective view of a closure member usable in a pest deterrent device, showing the closure member in a closed position;

FIG. 4b is a perspective view of the closure member of FIG. 4a, showing the closure member in an open position;

FIG. 4c is a perspective view of the closure member of FIG. 4a in a pest deterrent device;

FIG. 5a is a perspective view showing another style of closure member in an open position;

FIG. 5b is another perspective view of the closure member of FIG. 5a;

FIG. 5c is a perspective view showing the closure member of FIG. 5a in a pest deterrent device;

FIG. 6a is a perspective view showing an example support structure for a pest deterrent device;

FIG. 6b is a perspective view showing the support structure of FIG. 6a in a pest deterrent device;

FIG. 7a is a perspective view showing an example sponge that can be placed within a pest deterrent device;

FIG. 7b is a perspective view showing the sponge of FIG. 7a placed within a housing of a pest deterrent device;

FIG. 7c is a perspective view showing the sponge of FIG. 7a placed within an assembled pest deterrent device;

FIG. 8a is a perspective view of an alternative example pest deterrent device containing a sponge;

FIG. 8b is a perspective view showing the pest deterrent device of FIG. 8a, without a sponge;

FIG. 9 is a perspective view showing an alternative pest deterrent device with a plurality of outlet ports and a removable blocking member;

FIG. 10a is a perspective view of an alternative pest deterrent device, showing a cylindrical housing with a closure member in an open position;

FIG. 10b is a perspective view of an alternative pest deterrent device, showing a cylindrical housing with a closure member in a closed position;

FIG. 10c is a perspective view of an alternative pest deterrent device, showing a cylindrical housing with a closure member in an open position;

FIG. 10d is a perspective view of an alternative pest deterrent device, showing a cylindrical housing with a closure member in a closed position;

FIG. 11a is a perspective view showing the pest deterrent device of FIG. 10a in a spherical support structure;

FIG. 11b is a perspective view showing the pest deterrent device of FIG. 10a in an alternative spherical support structure;

FIG. 11c is a perspective view showing the pest deterrent device of FIG. 10a in an alternative spherical support structure;

FIG. 11d is a perspective view showing the pest deterrent device of FIG. 10a in an alternative spherical support structure;

FIG. 11e is a perspective view showing the pest deterrent device of FIG. 10a in an ovoidal support structure;

FIG. 11f is an exploded perspective view showing the cylindrical housing of FIG. 10a and a sphere of absorbent material;

FIG. 11g is an assembled perspective view showing the cylindrical housing of FIG. 10a within the sphere of absorbent material;

FIG. 12a is an exploded perspective view showing an alternative pest deterrent device including a cylindrical housing and a support structure;

FIG. 12b is an assembled perspective view of the pest deterrent device of FIG. 12a;

FIG. 12c is an assembled perspective view showing an alternative pest deterrent device including the support structure of FIG. 12a and an alternative housing;

FIG. 13a is a perspective view showing an example sealed pest deterrent sack;

FIG. 13b is a perspective view showing the sealed pest deterrent sack of FIG. 13a with a flange;

FIG. 13c is a perspective view showing the sealed pest deterrent sack of FIG. 13a with an alternative flange;

FIG. 13d is a perspective view showing the sealed pest deterrent sack of FIG. 13a, having a flange with a hole for hanging the pest deterrent sack;

FIG. 13e is a perspective view showing an alternative pest deterrent sack, with a blocking member;

FIG. 13f is a perspective view showing an alternative pest deterrent sack with a plurality of outlet ports;

FIG. 13g is a perspective view showing an alternative pest deterrent sack with a single outlet port;

FIG. 13h is a perspective view showing the pest deterrent sack of FIG. 13c resting on the support structure of FIG. 12a;

FIG. 14 is a perspective view showing an alternative pest deterrent device, which resembles a lantern;

FIG. 15a is a perspective view showing another style of pest deterrent device resembling a lantern;

FIG. 15b is an exploded perspective view of the pest deterrent device of FIG. 15a, showing the housing separate from the lantern shaped support structure;

FIG. 15c is a perspective view showing a plurality of the lantern shaped pest deterrent devices of FIG. 15b, attached to a cord;

FIG. 16a is a perspective view showing an alternative pest deterrent device, which is adapted to be received between deck boards;

FIG. 16b is a perspective view showing the pest deterrent device of FIG. 16a situated between and supported by deck boards;

FIG. 17 is a perspective view showing a plurality of alternative pest deterrent devices with different decorative shapes and/or designs;

FIG. 18a is an exploded perspective view showing an alternative pest deterrent device, with a two-piece housing;

FIG. 18b is an assembled perspective view showing the pest deterrent device of FIG. 18a;

FIG. 18c is a perspective view showing another style of pest deterrent device with a two-piece housing;

FIG. 19 is a perspective view showing a plurality of pest deterrent devices attached to a cord;

FIG. 20a is a perspective view showing a plurality of pest deterrent devices attached to a net;

FIG. 20b is a perspective view showing a plurality of pest deterrent devices of different configurations attached to a net;

FIG. 20c is a perspective view showing a plurality of pest deterrent devices attached to a circular net;

FIG. 20d is a perspective view showing a plurality of pest deterrent devices attached to a decorative net;

FIG. 21 is a perspective view showing a plurality of pest deterrent devices attached to a belt of netting;

FIG. 22 is a perspective view showing a plurality of pest deterrent devices spaced apart;

FIG. 23a is an exploded perspective view showing an alternative pest deterrent device including a housing and a decorative base;

FIG. 23b is an assembled perspective view showing the pest deterrent device of FIG. 23a;

FIG. 24a is a perspective view showing a pest deterrent sack and a raised net structure;

FIG. 24b is a perspective view showing a plurality of pest deterrent sacks resting on the raised net structure of FIG. 24a;

FIG. 24c is a perspective view showing a plurality of pest deterrent sacks resting on an alternative raised net structure;

FIG. 24d is a perspective view showing a pest deterrent sack resting on an alternative raised net structure;

FIG. 24e is a perspective view showing a plurality of pest deterrent sacks resting on an alternative raised net structure;

FIG. 25a is a perspective view of a net bag for receiving a pest deterrent device;

FIG. 25b is a perspective view of a pest deterrent device within the net bag of FIG. 25a;

FIG. 25c is a perspective view of another style of pest deterrent device within the net bag of FIG. 25a;

FIG. 25d is a perspective view of another style of pest deterrent device within the net bag of FIG. 25a;

FIG. 26a is a perspective view of a pest deterrent device including a rectangular housing having a plurality of outlet ports;

FIG. 26b is a perspective view of an alternative pest deterrent device including a rectangular housing having legs and a plurality of outlet ports;

FIG. 26c is a perspective view of an alternative pest deterrent device including a rectangular housing having handles and a plurality of outlet ports;

FIG. 27a is a perspective view showing an alternative pest deterrent device having a closure member with a handle;

FIG. 27b is a perspective view showing another style of pest deterrent device having a closure member with a handle;

FIG. 28a is a perspective view showing a foldable net for supporting one or more pest deterrent devices;

FIG. 28b is a perspective view showing an alternative foldable net for supporting one or more pest deterrent devices;

FIG. 28c is a perspective view showing the foldable net of FIG. 28b in a folded position;

FIG. 28d is a perspective view showing a plurality of pest deterrent devices placed on a foldable net;

FIG. 28e is a perspective view showing a plurality of pest deterrent devices placed on a raised foldable net.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any exclusive right granted by issuance of this patent application. Any invention disclosed in an apparatus or process described below and for which an exclusive right is not granted by issuance of this patent application may be the subject matter of another protective instrument, for example, a continuing patent application, and the applicants, inventors or owners do not intend to abandon, disclaim or dedicate to the public any such invention by its disclosure in this document.

The pest deterrent devices disclosed herein are useful for repelling pests such as raccoons from an area or territory, primarily by emitting a pest deterrent gas (e.g. ammonia vapour). The pest deterrent gas may be emitted from a volatile deterrent agent at a suitable rate to establish a persistent odour strong enough to deter raccoons and/or other pests from encroaching on (e.g. fouling and/or taking up residence in) outdoor areas, without being so strong so as to be detectable by humans in or near the outdoor area. That is, in some examples, the pest deterrent devices may be considered odourless to humans, but repellent to pests due to their relatively higher sensitivity of smell.

Successful tests have been carried out using ammonia as a deterrent agent. Ammonia, like urine, produces an odour (i.e. produces an odorous pest deterrent gas) that is offensive to pests such as raccoons. Prototype pest deterrent devices filled with ammonia were placed near houses and successfully deterred raccoons. For example, raccoons had taken up residence under a neighborhood deck, and were using the area near a basement window as a latrine. Pest deterrent devices were placed spaced apart in the problem areas (at an opening in the deck and near the basement window). An adult raccoon and three raccoon cubs vacated their hide away under the deck in broad daylight. One of the cubs dragged one of the pest deterrent devices into what was presumed to be their den, and the adult raccoon subsequently gathered up the raccoon cubs and left the territory in broad daylight.

Research was also carried out at other properties. The results were positive; raccoons were deterred from the environment in which the pest deterrent devices were placed. The pest deterrent devices appeared to effectively deter raccoons over a period, typically, from about 6 months to about one year. Tests have shown that pest deterrent devices can continue to protect a property for over a year (a harsh winter may necessitate replacement of the pest deterrent devices in the spring). The pest deterrent devices may also be decorative. One can hook or place the pest deterrent devices in raccoon targeted territories such as: dark pathways, decks, corners, trees, gates, in flower beds, lawns, on roofs or fences, etc. Pest deterrent devices can also be used in sheds, in attic areas, and/or under decks.

Without being limited by theory, the deterrent sacks are thought to act as scent markers to the raccoons. That is, raccoons encountering deterrent sacks react as if “someone” has been there already and claimed the territory; their instinct is to proceed with caution. However due to the smell, raccoons will try to avoid areas where they are placed.

One possible advantage of the deterrent devices disclosed herein is their ability to retain their smell not just for a few days or weeks but for longer periods such as an entire spring, summer and/or fall season. Tests have shown that even throughout the winter deterrent sacks have proven effective. However, some embodiments will require periodic replacement or replenishment of the deterrent agent.

Another possible advantage of the deterrent sacks disclosed herein is their ability to be attached to objects. By attaching one or more pest deterrent devices to objects, one can deter raccoons from absconding with them.

Pest deterrent devices may have other pest applications. For example, foxes and some other animal pests are also deterred by ammonia. Household pets may also be deterred from specific areas with the use of pest deterrent devices disclosed herein. In addition, pest deterrent devices disclosed herein may be used to deter bears.

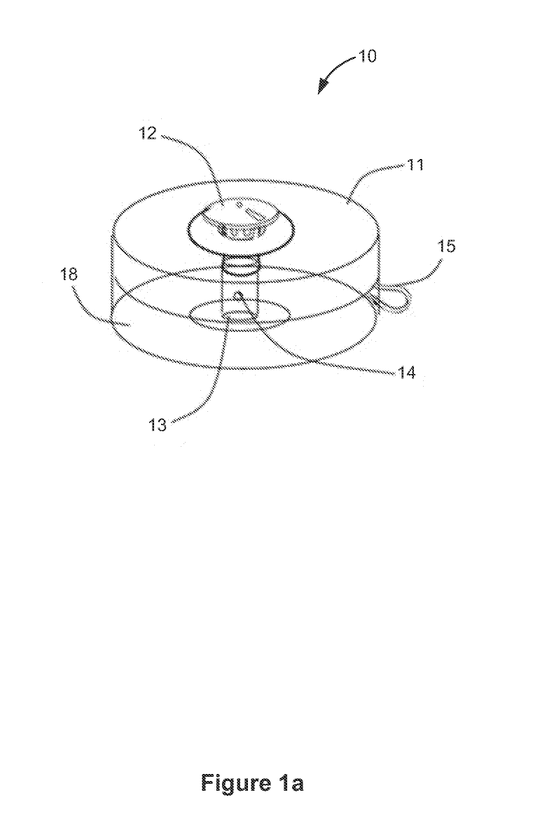

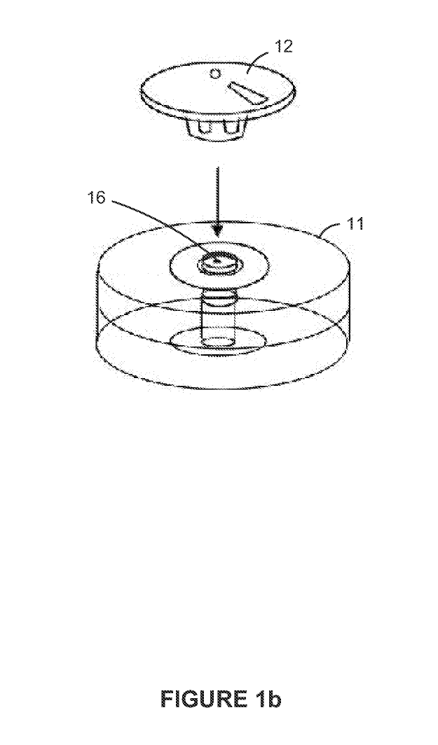

FIG. 1 shows an example pest deterrent device 10. Pest deterrent device 10 includes a housing 11 defining an interior chamber that contains a volatile deterrent agent 18 that produces a pest deterrent gas. Pest deterrent device 10 also has a tube 13 in fluid communication with the interior of the housing 11, in this example via hole 14 located in tube 13. Pest deterrent device 10 also comprises an outlet port (not shown in FIG. 1), which in the example shown is provided in the end of the tube 13, and a closure member 12 that allows for the outlet port to be selectively opened and closed. That is, closure member 12 can be adjusted such that the interior of the housing is alternately in fluid communication with the exterior environment via the outlet port and, in this example, tube 13 and hole 14. Pest deterrent gas enters the tube via hole 14, and exits the tube via the outlet port, where it produces an odour that repels pests.

The example pest deterrent device 10 shown in FIG. 1 also includes optional loop 15 for releaseably attaching the pest deterrent device to another object, such as a support for suspending the pest deterrent device, or to prevent unwanted movement of the pest deterrent device.

Housing 11 may be made from any suitable material, and in some embodiments may be made of a rigid or flexible plastic, such as high-density polyethylene (HDPE) or low-density polyethylene (LDPE). In some embodiments, a cotton-reinforced HDPE may be used, which typically creates a stronger, more tear-resistant housing as compared to un-reinforced plastics. In some embodiments, housing 11 may be made from paper or other biodegradable materials. In some embodiments, housing 11 may be made from a metallic foil. In some embodiments, housing 11 and/or other components of the pest deterrent device may be made from recycled and/or recyclable materials. In some embodiments, housing 11 may be a flexible plastic sack.

The dimensions of the pest deterrent devices disclosed herein, including the cross sectional area of the outlet port(s) and the interior surface area of the housing, may be selected to optimize the gas output rate of the pest deterrent device. The use of smaller outlet ports may prevent rapid evaporation of the volatile deterrent agent, thus increasing the amount of time a pest deterrent device will be effective before requiring replenishment or replacement of the volatile deterrent agent. Other factors that may be taken into consideration include the environment in which the pest deterrent device is to be placed, the deterrent agent to be used, and the pest to be deterred.

In embodiments with one or more outlet ports, each outlet port may have a diameter of about 2 mm, or a diameter of about 1 mm, or a diameter of less than about 1 mm. In embodiments with one or more outlet ports, the size of each outlet port need not be the same.

FIG. 1b is a perspective view showing a pest deterrent device with the closure member 12 removed to show an outlet port 16 through which the pest deterrent gas can escape. In some embodiments, closure member 12 may act as a blocking member to shield the outlet port 16 from solid debris (e.g. sand) and/or rain or other liquids. For example, as shown in FIG. 1b, the closure member 12 may rest on or above the outlet port 16, such that pest deterrent gas can escape from the outlet port and be diffused laterally from under the blocking member. Alternatively, a separate blocking member may be provided, either as an additional component, or integrated into the shape of the housing 11.

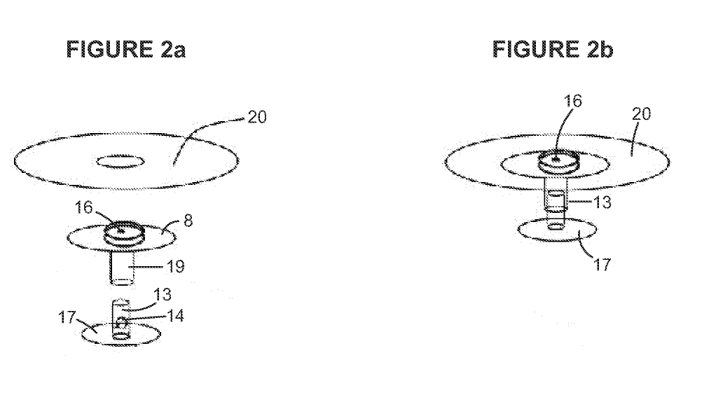

FIGS. 2a and 2b show an assembly including tube 13 supported by tube base 17. A hole 14 in a sidewall of tube 13 allows the pest deterrent gas to flow into the tube 13, such that the pest deterrent gas flows up the tube 13 and out of the outlet port 16. An upper tube section 19 is connected to a rigid support ring 8, and the outlet port 16 is provided in the rigid support ring. As shown, upper tube section 19 engages with tube 13 to provide a passage from hole 14 to outlet port 16 through which the pest deterrent gas can flow. The tube sections may be connected by a friction fit, a screw fit, or any other suitable connection method. In some embodiments, a single tube connecting tube base 17 and support ring 8 may be used.

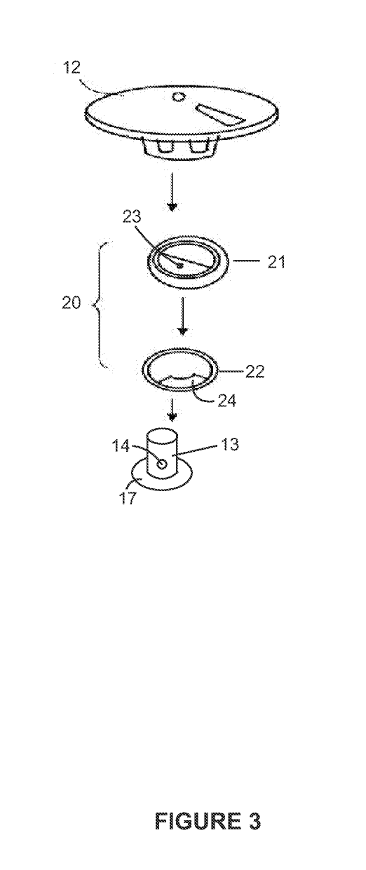

FIG. 3 shows a rotational closure member 20 that can be twisted to selectively allow fluid communication between the interior and exterior of a pest deterrent device (i.e. to open and close the outlet port). Rotational closure member 20 comprises disc shaped upper and lower sections 21 and 22, respectively, which when fitted together allow relative rotation about a central axis. In use, opening 23 in upper section 21 and opening 24 in lower section 22 can be aligned by rotating the upper and lower sections relative to each other, such that when the openings 23 and 24 are aligned, the interior of the housing is in fluid communication with the exterior environment, and when the openings 23 and 24 are not aligned, the interior of the housing is not in fluid communication with the exterior environment. In the embodiment shown in FIG. 3, closure member 12 engages with upper section 21 of rotational closure member 20, such that rotation of closure member 12 effects rotation of upper section 21, allowing rotational closure member 20 to be opened and closed by rotating closure member 12. In this embodiment, closure member 12 acts as a blocking member.

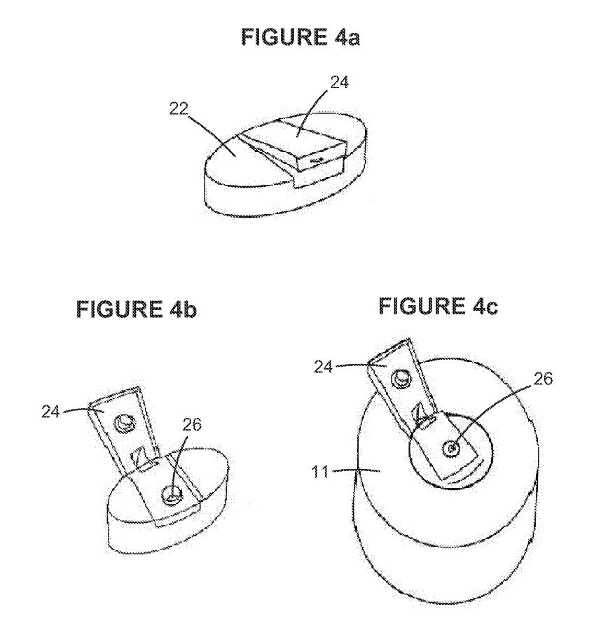

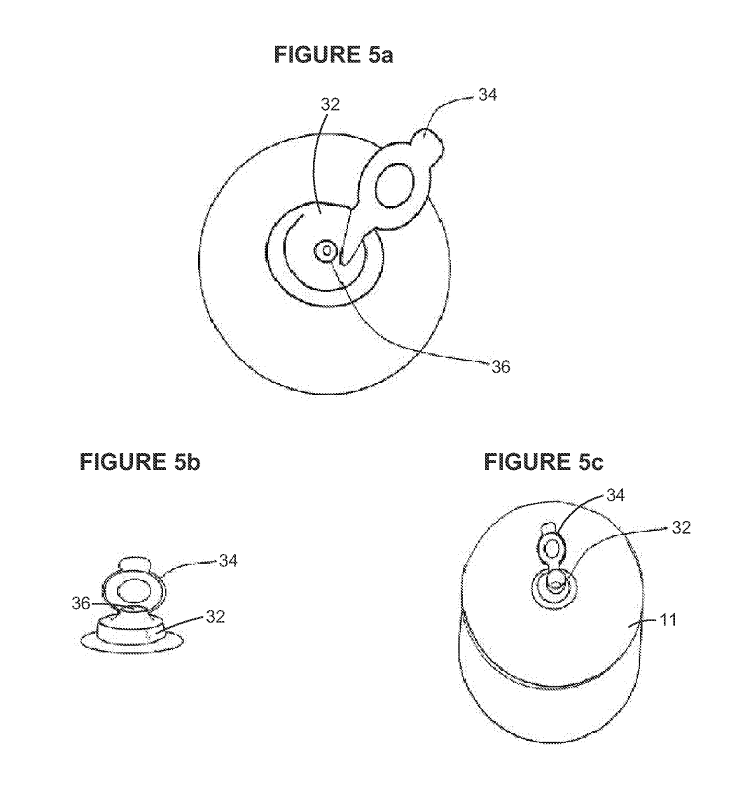

FIG. 4a shows a hinged closure member consisting of a base 22 and a member 24 hingedly attached to the base. Member 24 can be manipulated between an open position in which a pest deterrent gas can flow through outlet port 26, and a closed position (as shown in FIG. 4b) wherein a surface or projection on member 24 releasably sealably engages with outlet port 26 to prevent the flow of pest deterrent gas. In some embodiments, the hinged attachment between member 24 and base 22 may bias member 24 towards a position where it shields, but does not sealingly engage, outlet port 26, thereby acting as a blocking member when the hinged closure member is in the open position. FIG. 4c illustrates another style of hinged closure member attached to a housing 11. Other examples of closure members are shown in FIGS. 5a-5c.

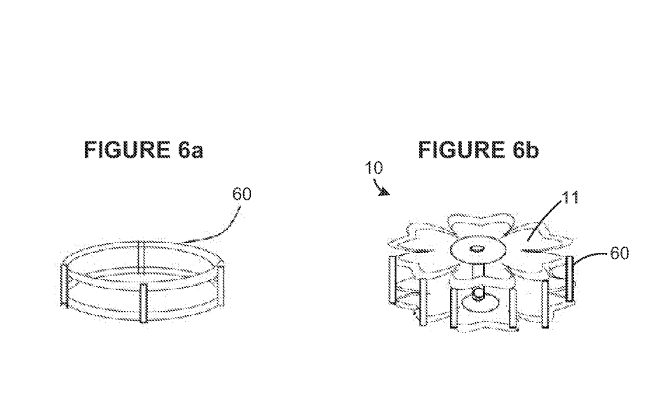

As previously described, housing 11 may be made from a variety of materials, including materials that are highly rigid, materials that are highly flexible, and materials that are somewhat flexible. In some examples, rigid (or semi-rigid) support structures may be coupled to the housing to support the housing 11. This may be particularly useful in examples where the housing is flexible. In the examples described above with respect to FIGS. 1 to 3, the tube 13 serves as a support structure. FIG. 6a shows an alternative support structure 60, which can be attached to the interior or exterior of the housing 11. In some embodiments, support structures may be designed to enhance the aesthetic appearance of the pest deterrent device. FIG. 6b shows a flower-shaped support structure 60 being used to support a housing 11 in a more decorative embodiment of pest deterrent device 10.

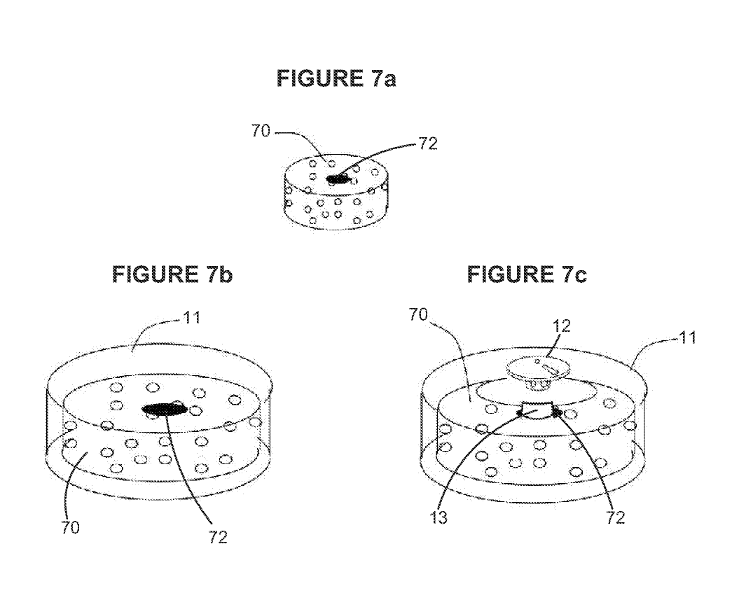

In some embodiments, an absorbent material such as the sponge 70 shown in FIG. 7a is provided inside the housing 11. Sponge 70 may absorb and adsorb the volatile deterrent agent to regulate the production of the pest deterrent gas. Additionally, or alternatively, sponge 70 may act as an interior support for a pest deterrent sack. The sponge may be shaped to accommodate the particular shape of the housing (or sack) 11 in which it is to be installed. For example, hole 72 may be provide to accommodate another interior structure such as tube 13 (see e.g. FIG. 7c). FIG. 7b shows the sponge 70 disposed within a housing 11, and FIG. 7c shows the sponge of FIG. 7a placed within a pest deterrent device as shown in FIG. 1.

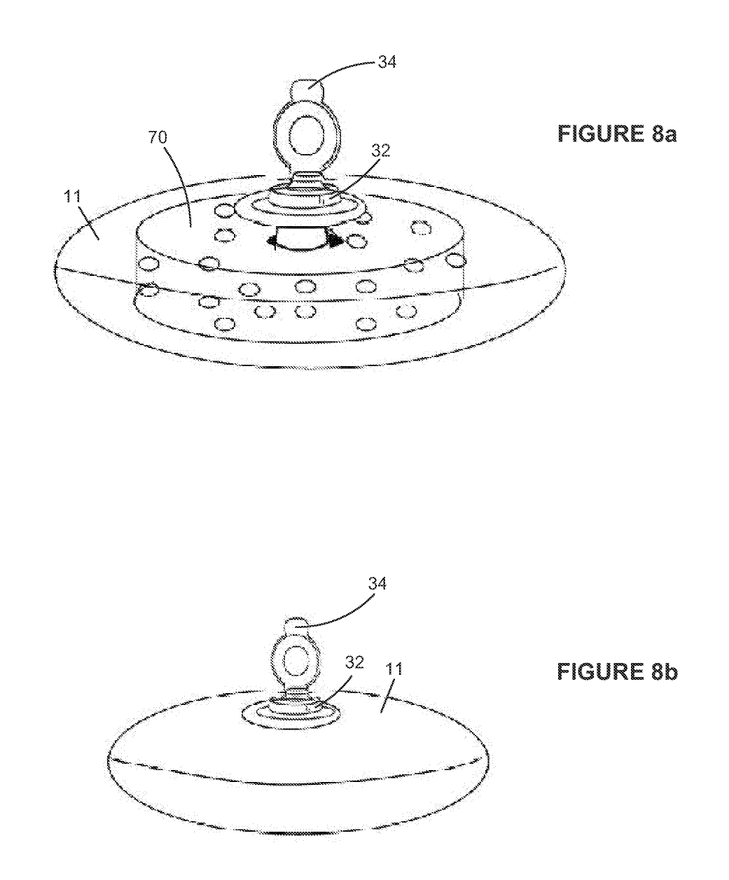

FIG. 8a shows a sponge providing structural support from within an oblate flexible housing (sack) 11. FIG. 8b shows a pest deterrent device comprising an oblate flexible sack 11 without an interior support.

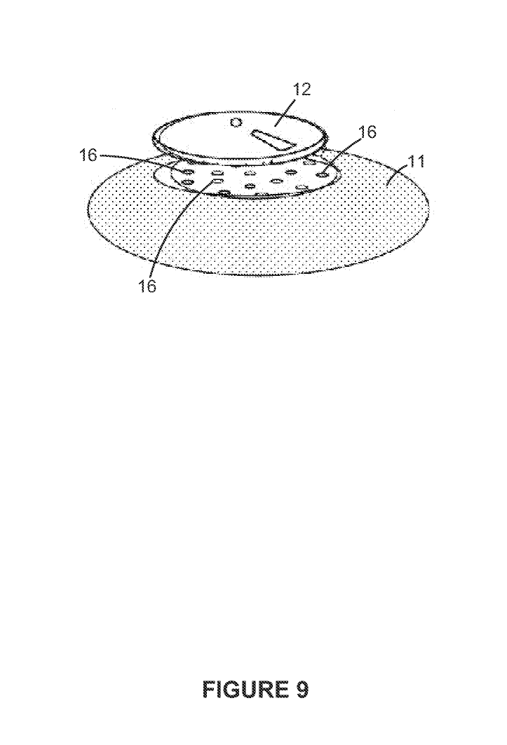

FIG. 9 shows a pest deterrent device with a plurality of outlet ports 16 in the housing 11, and a removable closure member 12. As discussed above, in some embodiments the closure member may be designed to rest on or above the plurality of outlet ports, thereby acting as a blocking member to prevent rain or other undesirable substances from entering or obscuring the outlet ports. In some embodiments, the closure member of a pre-filled pest deterrent device may be removed at the time of initial placement/installation of the pest deterrent device.

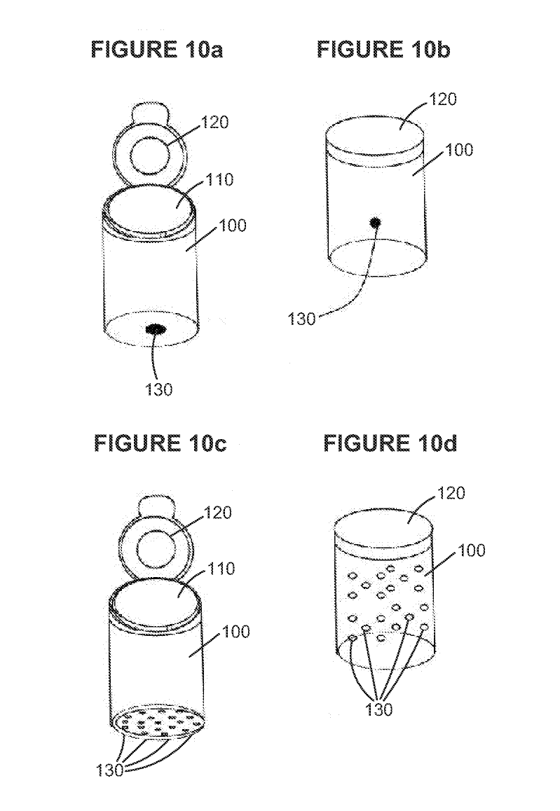

As shown in FIG. 10a, in some embodiments the pest deterrent device may comprise a rigid cylindrical housing 100 with a re-sealable opening 110 at one end and an outlet port 130 at the other end. Volatile deterrent agents, particularly solid volatile deterrent agents, can be inserted into the cylindrical housing 100 via the re-sealable opening 110. While a hinged closure member 120 is shown, persons skilled in the art will recognize that any type of re-sealable closure mechanism may be used. Also, outlet port 130 may alternatively be provided on a side wall of the cylindrical housing 100, as shown in FIG. 10b. Also, cylindrical housing 100 may be provided with a plurality of outlet ports 130 at an end wall (as shown in FIG. 10c), at the side wall (as shown in FIG. 10d), or on both the end wall and the side wall (not shown).

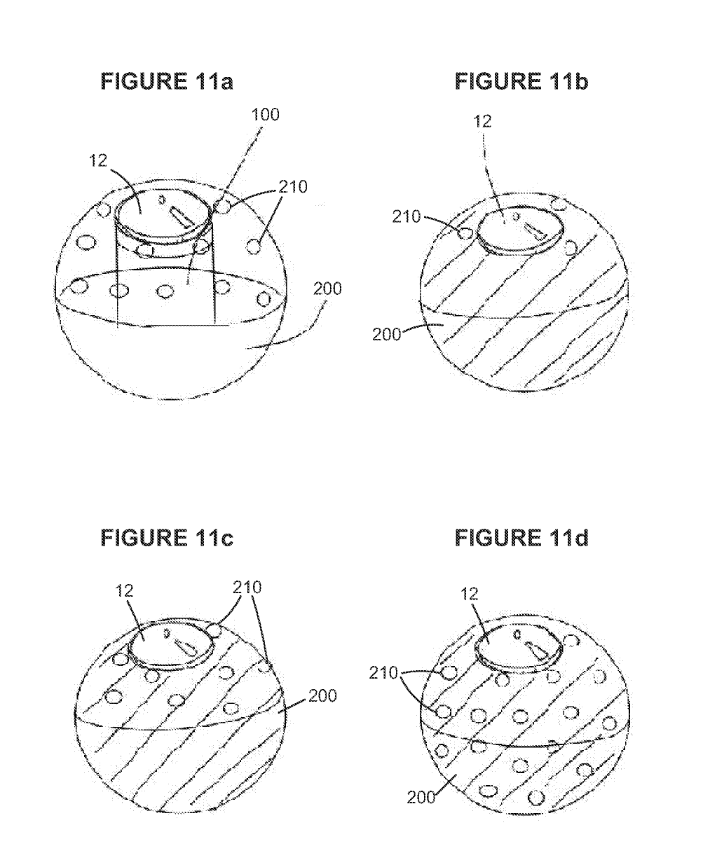

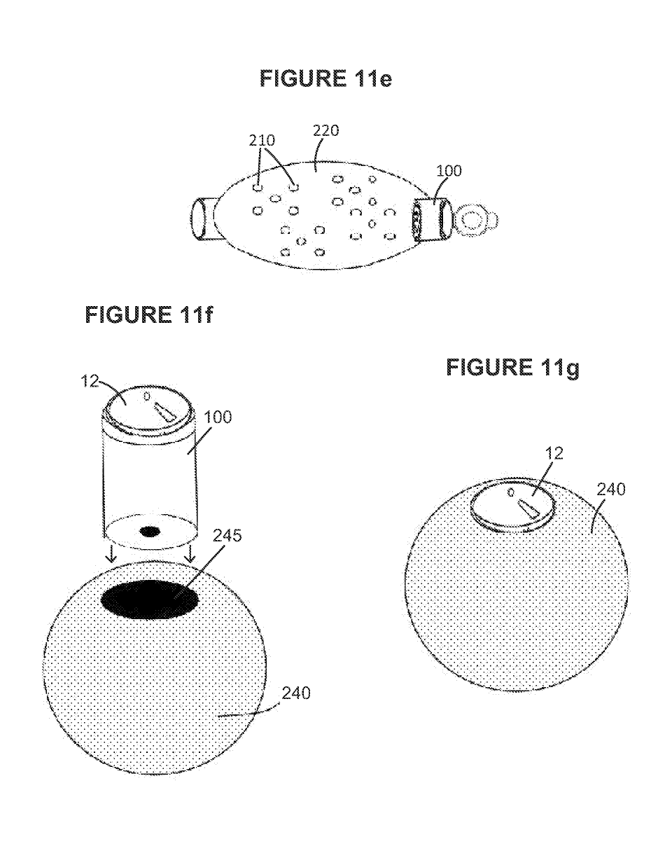

In some embodiments, a rigid cylindrical housing 100 may be placed within a spherical support structure 200, as shown in FIGS. 11a-11d. Spherical support structure 200 may have one or more holes 210 to allow passage of pest deterrent gas emitted from a volatile deterrent agent located within cylindrical housing 100 to escape to the exterior of spherical support structure 200. In some embodiments, an ovoidal support structure 220 may be provided, as shown in FIG. 11e.

In some embodiments, a spherical support structure made of absorbent material, such as spherical support structure 240 shown in FIGS. 11f and 11g may be provided. A cylindrical support structure 100 may be filed with a volatile deterrent agent and placed within the spherical support structure 240.

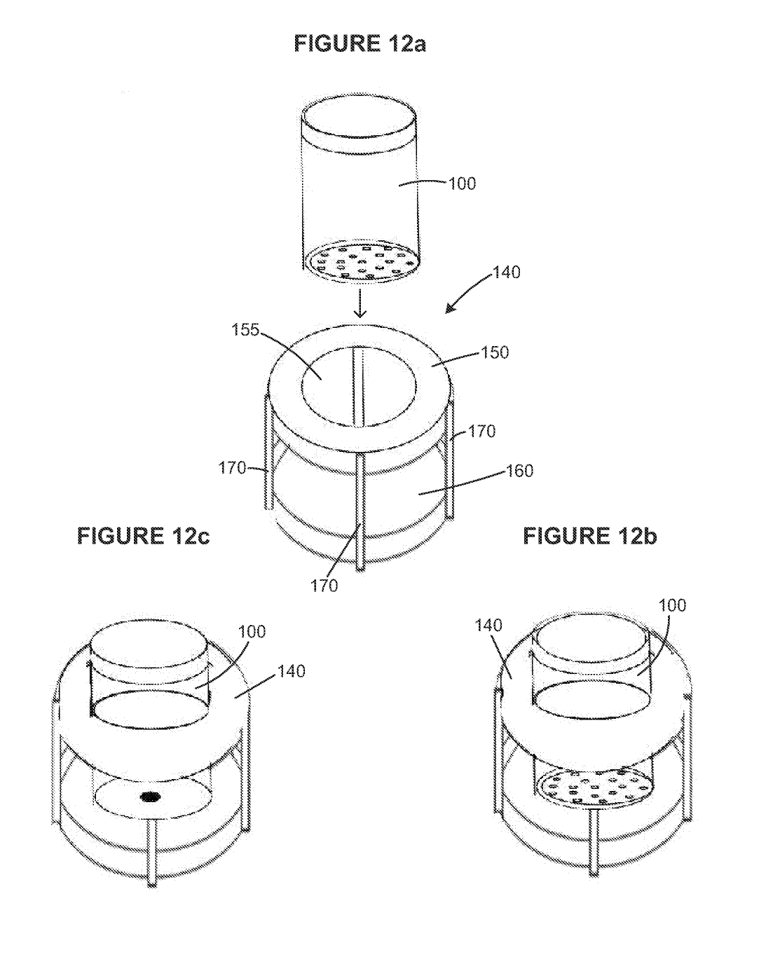

In some embodiments, cylindrical housing 100 may be placed in a holder 140 to support the cylindrical housing 100 to allow a pest deterrent gas to escape from one or more outlet ports located on the bottom of the cylindrical housing, as shown in FIG. 12a. Holder 140 comprises an upper support member 150, a lower support member 160, and one or more vertical support members 170. Cylindrical housing 100 is inserted through an opening 155 in the upper support member 150 so that it rests on or above the lower support member 160, as shown in FIGS. 12b and 12c.

While the pest deterrent gas generally passes from the interior of the housing to the exterior surroundings of the pest deterrent device via one or more outlet ports, in some embodiments the housing 11 is made from a material that is permeable to the pest deterrent gas, and impermeable to the volatile deterrent agent. The use of such a gas-permeable housing may allow the pest deterrent device to emit the pest deterrent gas at a greater rate than pest deterrent devices with a gas impermeable housing.

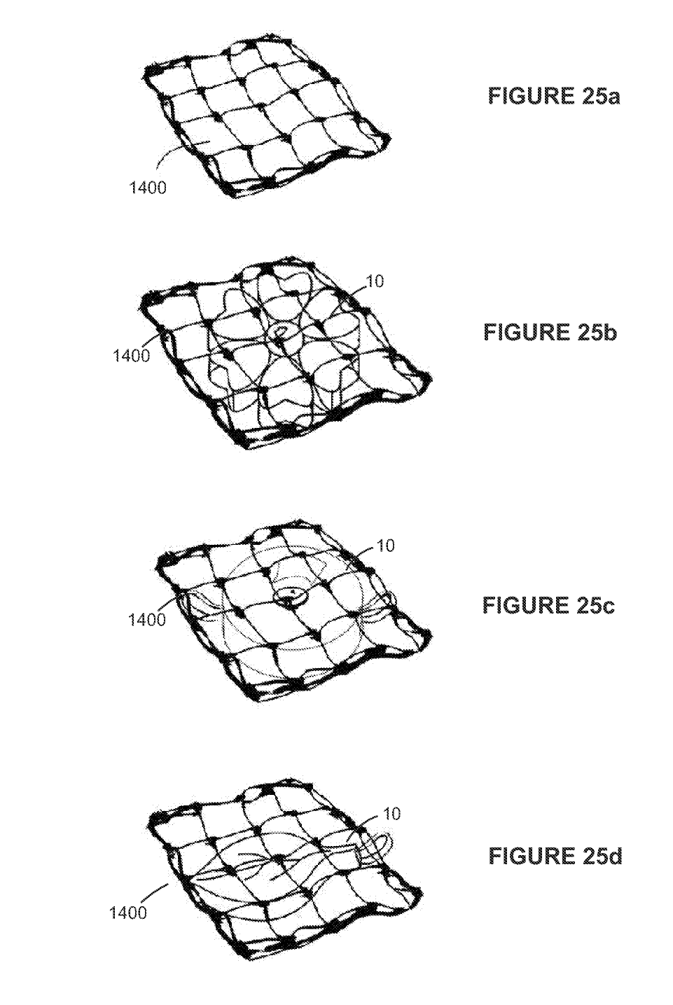

The use of a gas-permeable housing may also allow the volatile deterrent agent to be substantially sealed within the pest deterrent device. That is, an outlet port may not be provided in some embodiments. While the effectiveness is typically relatively greater in embodiments with an outlet port (i.e. a physical vent) due to the typically greater volume of pest deterrent gas emitted within a given period of time, a totally enclosed sack may be useful in some circumstances. For example, a pest deterrent device without an outlet port may be preferable for use in areas where young children may frequent. Embodiments with larger outlet ports may be more useful in relatively remote problem areas that are unlikely to be frequented by children. Alternatively, the pest deterrent devices may be enclosed in a protective net or bag (see e.g. FIGS. 25a-d) to protect children from attempting to play with or open the pest deterrent devices.

Also, embodiments without outlet ports may be pre-filled with a deterrent agent, which may provide ease and convenience to a user. That is, a user may simply place and leave the pest deterrent device.

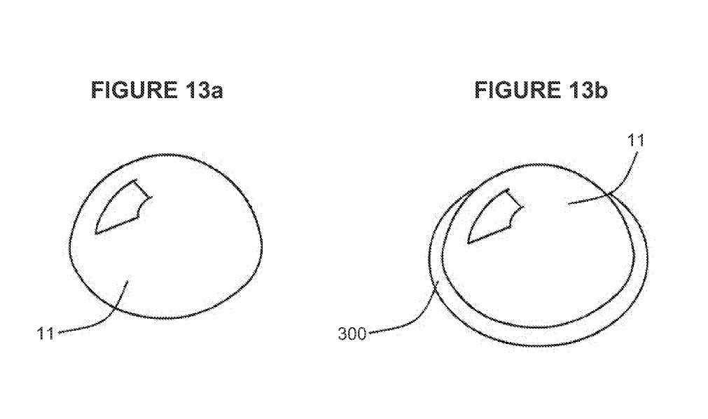

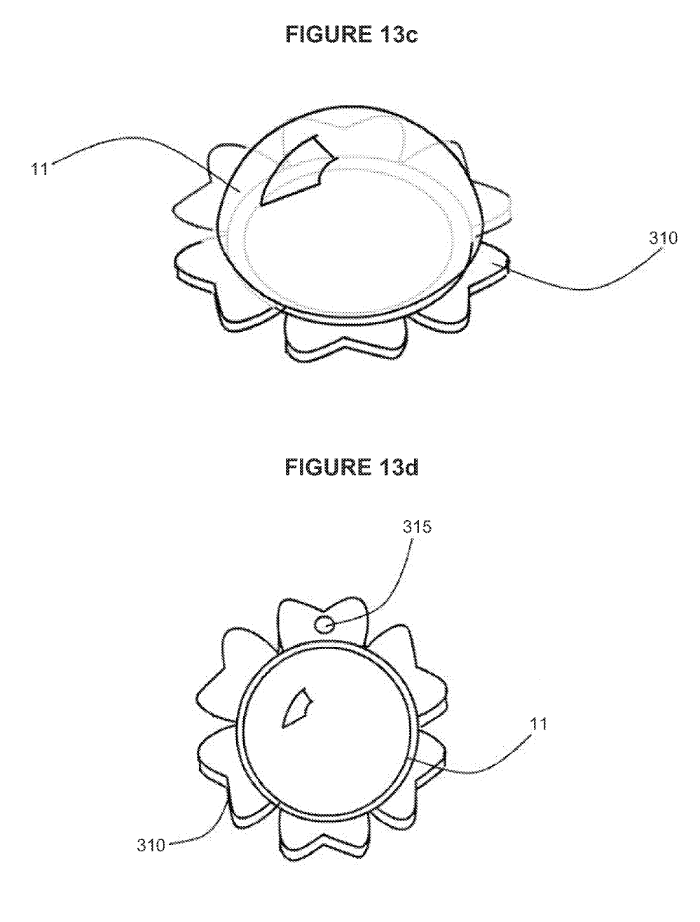

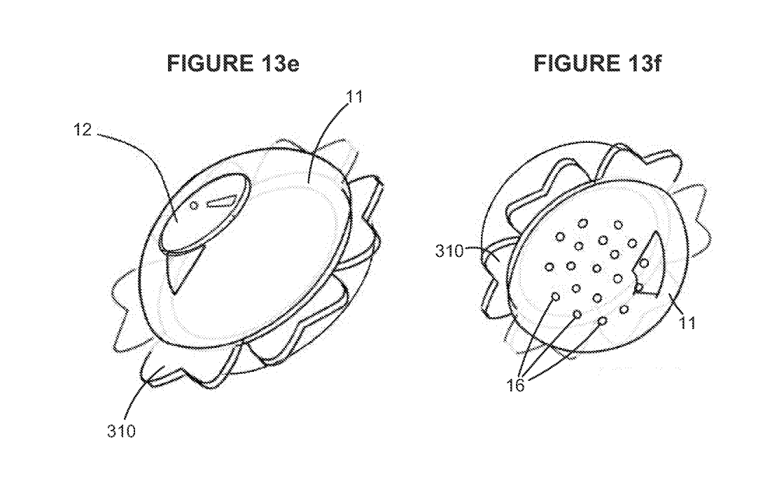

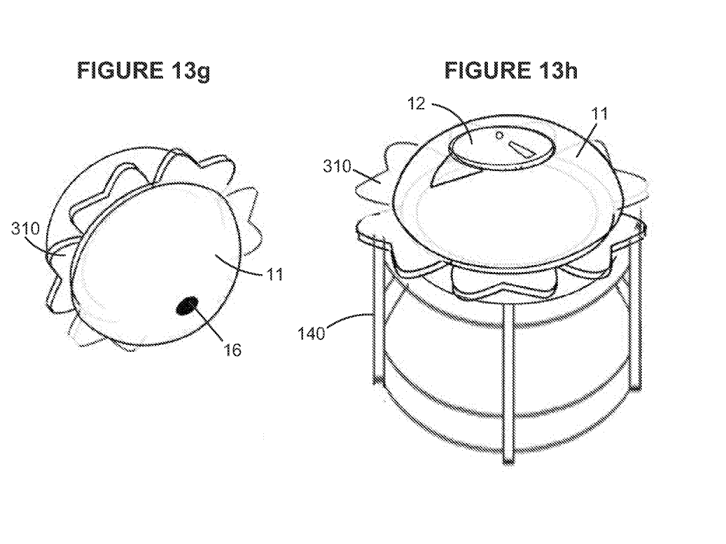

FIG. 13a shows a pest deterrent device that includes a sealed housing 11 (also referred to as a sack 11). A sealed pest deterrent sack 11 may be provided with a flange 300, as shown in FIG. 13b, either to provide a means for attaching such a deterrent sack to a support structure or other object, or as a result of a heat-sealing manufacturing process used to create a sealed, liquid-filled sack. Such a flange may also have a decorative aspect, for example as shown in FIG. 13c, and optionally may be provided with a hole 315 for mounting or hanging the deterrent sack 11, as shown in FIG. 13d.

Alternatively, a sealed sack may be placed on a holder 140, as shown FIG. 13h.

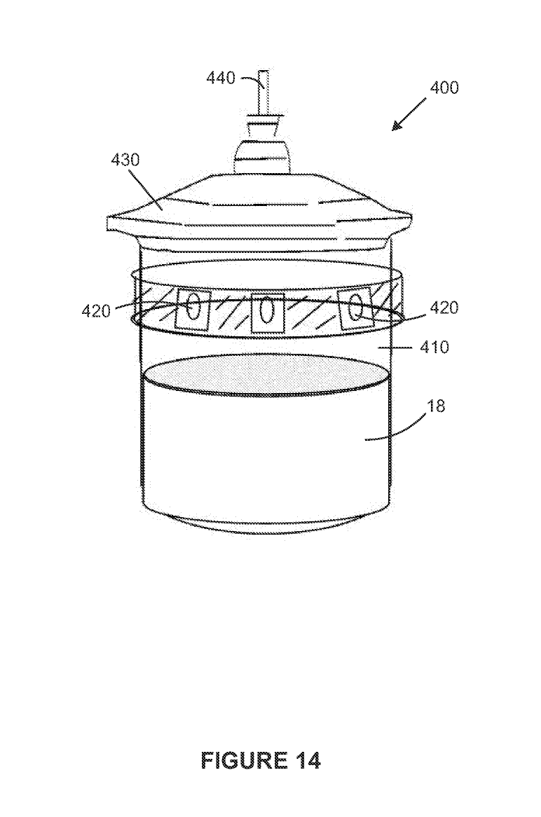

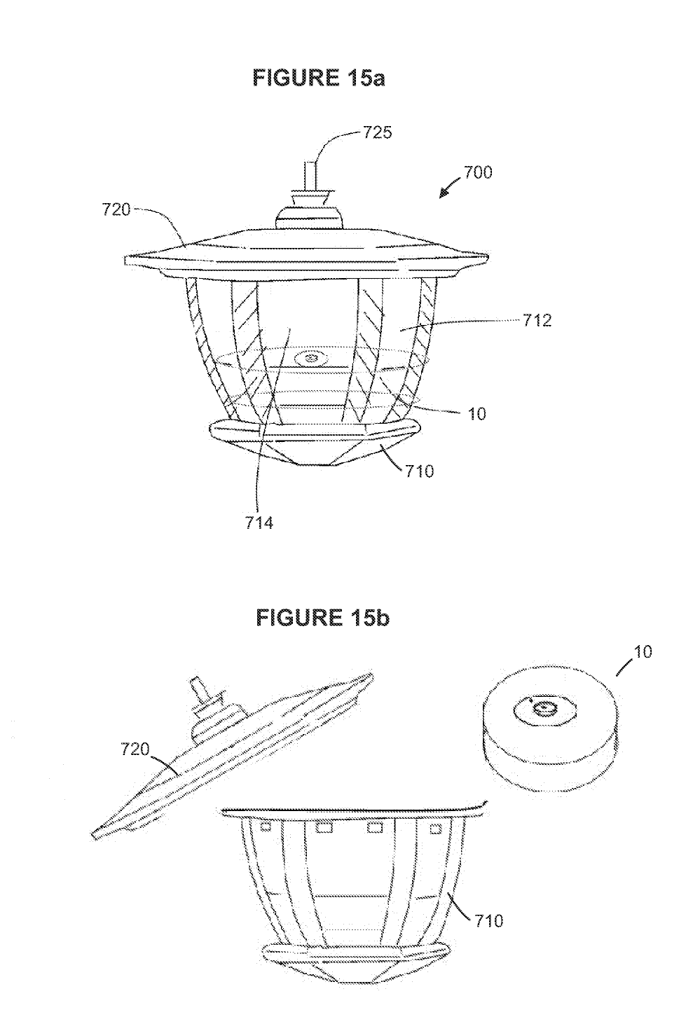

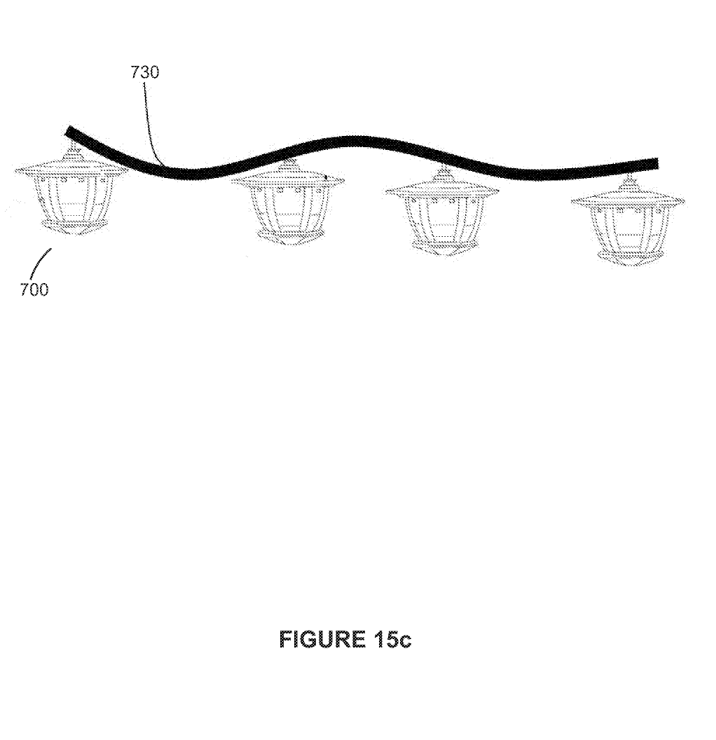

In some embodiments, a pest deterrent device in the shape of a lantern is provided. Such pest deterrent devices may include a lantern-shaped housing or a lantern-shaped support structure. A non-limiting example of a lantern-shaped housing is shown in FIG. 14. Lantern 400 comprises a housing 410 and a removable lid 430. A volatile deterrent agent 18 may be placed directly in the housing 410. The housing 410 includes one or more openings 420 to allow the odor from the volatile deterrent agent 18 to escape. A non-limiting example of a lantern-shaped support structure is shown in FIGS. 15a and 15b. Lantern 700 comprises a support structure 710 consisting of and one or more support members 712 and a removable lid 720. A pest deterrent device 10 (e.g. a deterrent sack) may be placed within the support structure 710. The support structure 710 includes one or more openings 712 to allow the odor from the pest deterrent device 10 to escape. Pest deterrent lanterns 400, 700 can be hung by attachment members 440, 725 on decks, staked in pots, hung on fences, on eves, in corners, in trees, in shrubs, etc. FIG. 15c shows a plurality of lantern shaped pest deterrent devices attached to a cord 730.

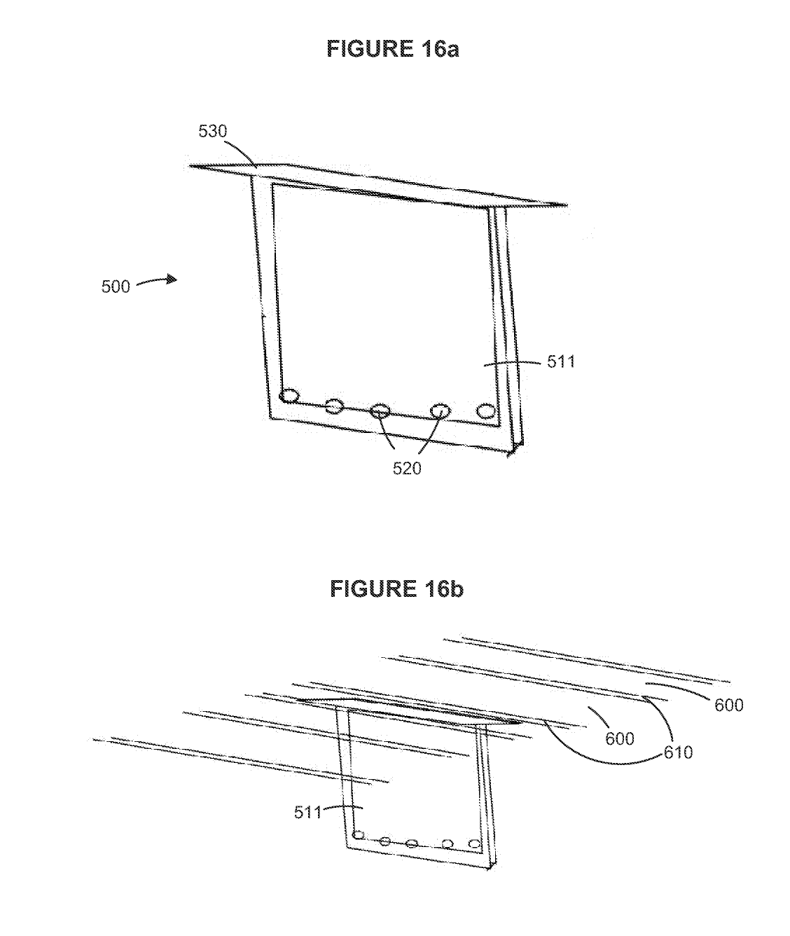

FIGS. 16a-b show a pest deterrent device 500 adapted to be received between deck boards 600. Pest deterrent device 500 comprises a rigid horizontal support 530 from which housing 511 hangs. Housing 511 may be filled with a volatile deterrent agent, and outlet ports 520 provide a means for the pest deterrent gas to escape. The dimensions of housing 511 are selected such that, in use, the lower edge of pest deterrent device 500 can be placed in a gap 610 between deck boards 600, and is lowered until the underside of horizontal support 530 contacts the upper surface of the deck boards 600, as shown in FIG. 16b.

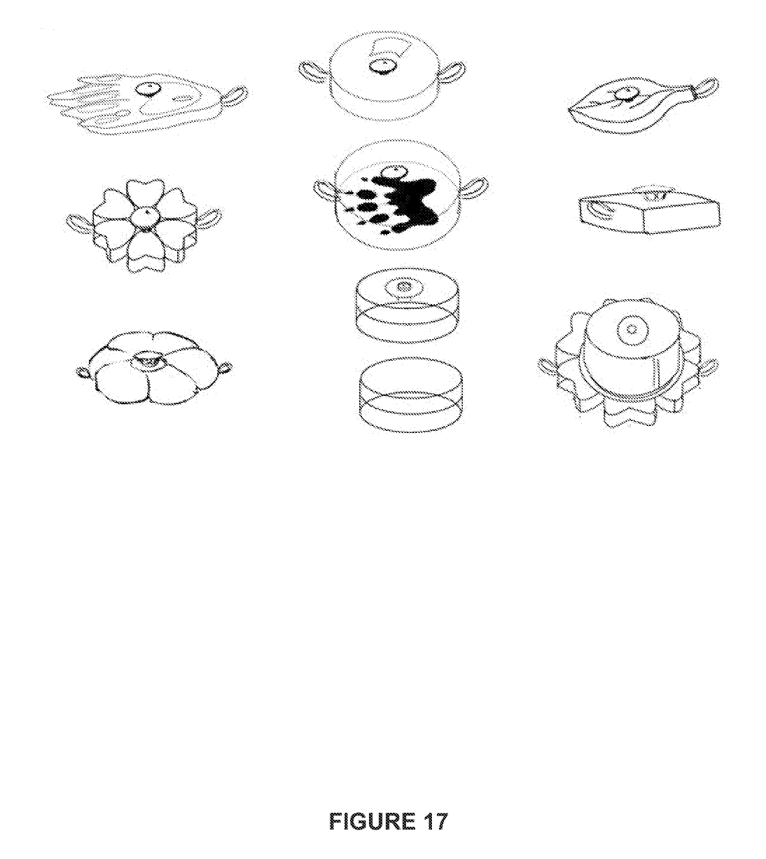

Pest deterrent devices may be manufactured in a wide variety of shapes, sizes, and colours. FIG. 17 shows a plurality of non-limiting examples of pest deterrent devices with different decorative shapes and/or designs. Pest deterrent devices may be designed so as to be appealing in a garden landscape.

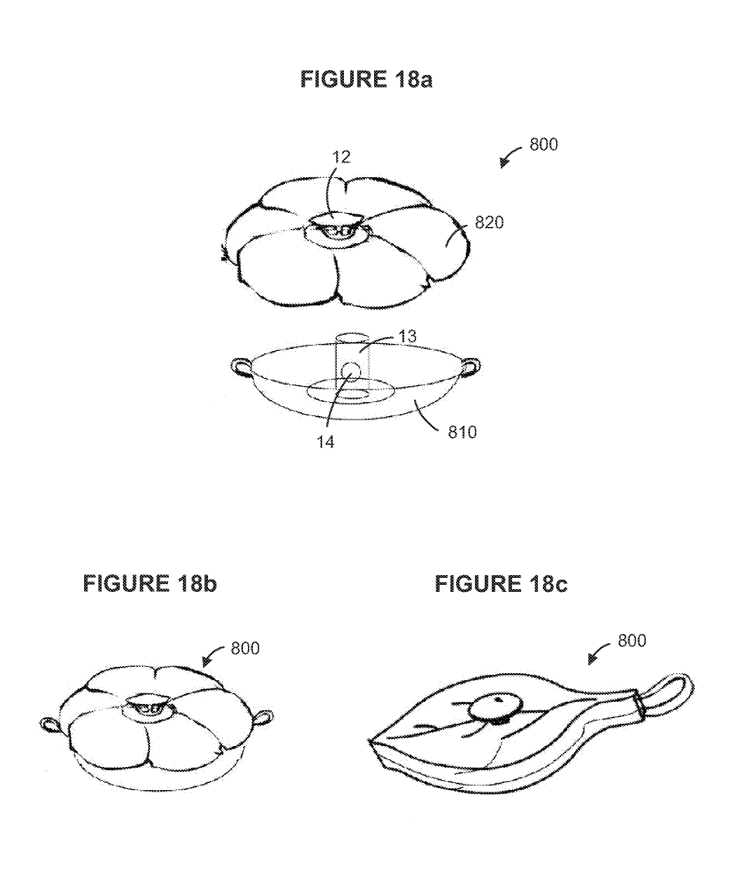

In some embodiments, a pest deterrent device may comprise a two piece housing, as shown in FIGS. 18a and 18b. Pest deterrent device 800 comprises a lower housing 810 and an upper housing 820, which in this example is designed to resemble a flower. In use, a volatile deterrent agent may be placed in the lower housing 810, which is then sealably attached to the upper housing 810. Accordingly, pest deterrent device 800 may be easily refillable. Pest deterrent gas emitted by the volatile deterrent agent may travel through the hole 14 in tube 13 to the exterior of the housing via one or more outlet ports (not shown). In this example, the flow of pest deterrent gas through the outlet port(s) is(are) controlled by a closure member 12, which in some embodiments may also act as a blocking member to shield the outlet ports from e.g. rain. FIG. 18c shows another style of pest deterrent device 800 with a two-piece housing.

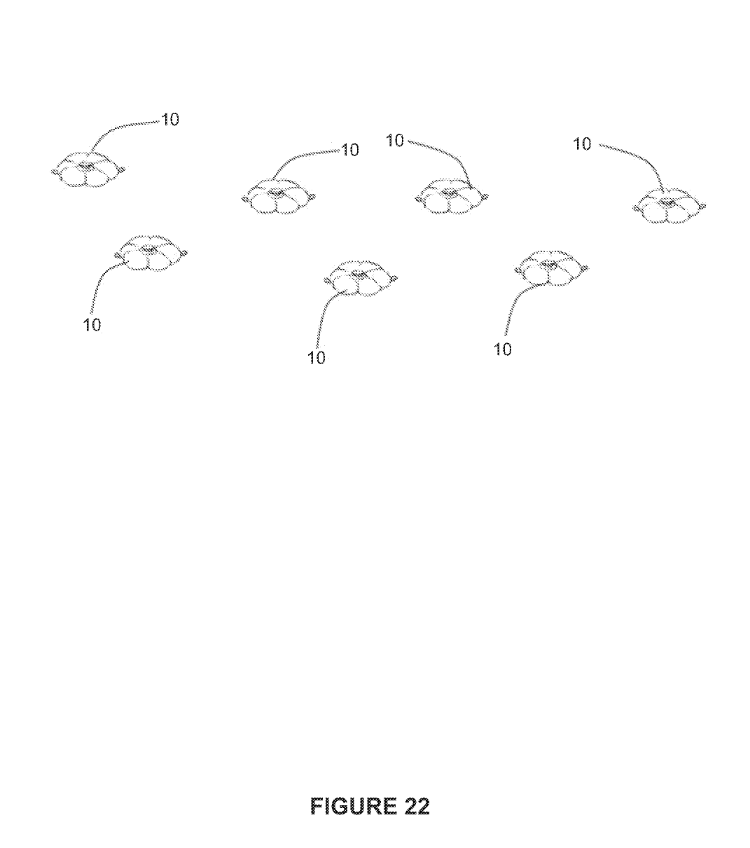

In order to deter pests from larger areas, a plurality of pest deterrent device may be used. That is, individual deterrent devices (e.g. sacks) can be spaced apart in a grid, random, or other formation (e.g. a footprint formation as shown in FIG. 22) in order to cover a larger area. For example, deterrent sacks may be placed about 30 to 40 cm apart.

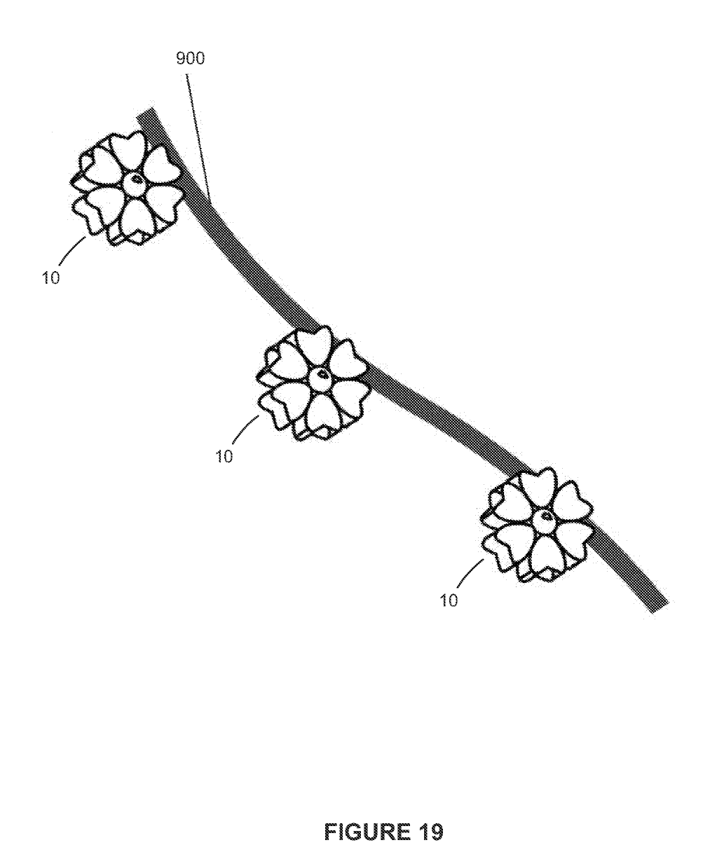

In order to facilitate the use of a plurality of pest deterrent devices, one or more devices may be attached to a support frame, which may be flexible, such as a cord, net, or other similar structure. For example, as shown in FIG. 19, a plurality of pest deterrent devices 10 can be attached to a cord 900. Such cords can be placed on railings, on or around trees, on or around shrubs, under decks, etc. More than one style or design of pest deterrent device can be attached to a cord.

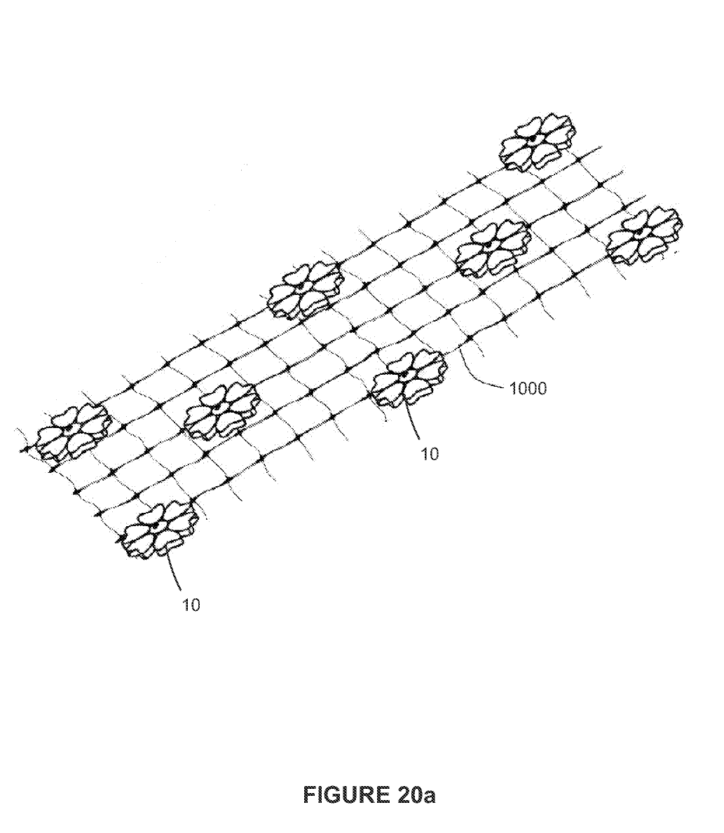

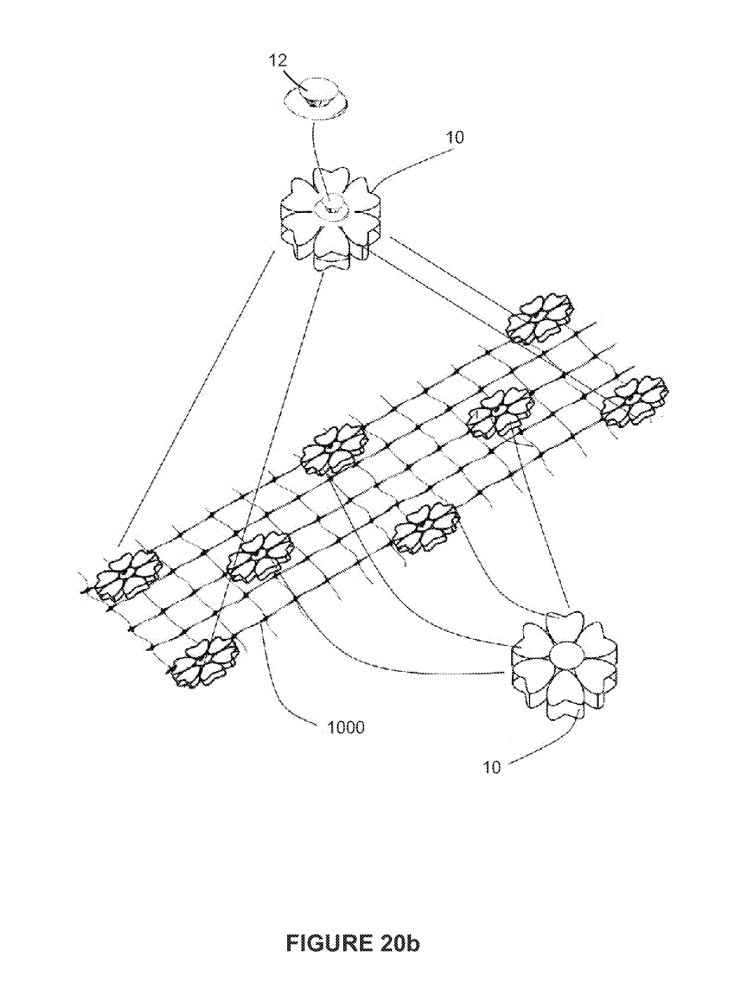

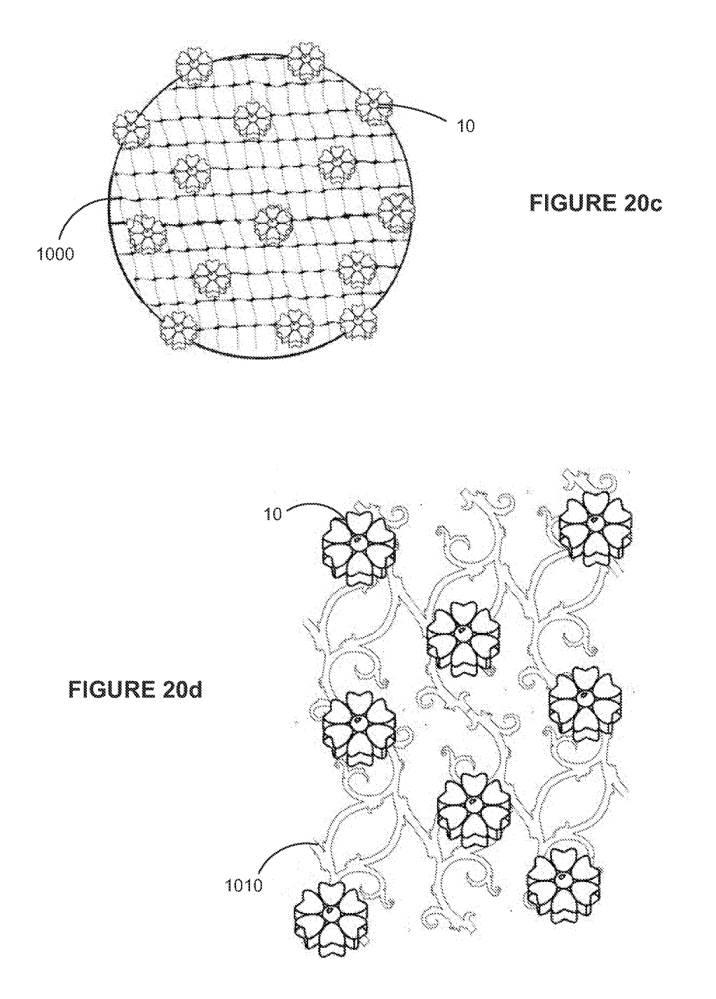

A flexible support frame may optionally include a web of spaced apart, cross-linked support strands, such as rope, chains, nets or belts. Each pest deterrent device may optionally be located at the intersection of two or more strands. The web optionally comprises an array of regularly spaced apart, parallel, longitudinal strands connected to a plurality of regularly spaced apart, parallel, latitudinal support strands. For example, one or more pest deterrent devices 10 can be attached to a net 1000, as shown in FIG. 20a.

Attaching a plurality of pest deterrent devices (e.g. deterrent sacks) to netting may provide a convenient way of covering wide areas (e.g. roofs, lawns etc.) providing ease of movement and for easy rotation to protect lawns. In this way, a net 1000 covering all or a portion of a lawn can be occasionally rotated or shifted laterally to allow covered grassy sections to breathe. For example, when laid over a grassy area, net 1000 can be rotated weekly to prevent the grass from yellowing due to lack of air and sunlight. Also, one can simply drag net 1000 out of the way when mowing, raking or cleaning a lawn or other surface on which the net is deployed.

Of course, a number of different shapes, sizes, and styles of pest deterrent devices may be attached to the same net 1000. For example, as shown in FIG. 20b, some pest deterrent devices attached to net 1000 may have a closure member 12, while some other pest deterrent devices may be sealed (as discussed above).

Similarly, a number of different shapes, sizes, and styles of netting may be used. For example, as shown in FIG. 20c, pest deterrent devices may be attached to a circular net 1000. As shown in FIG. 20d, a decorative netting 1010 may be used in some embodiments.

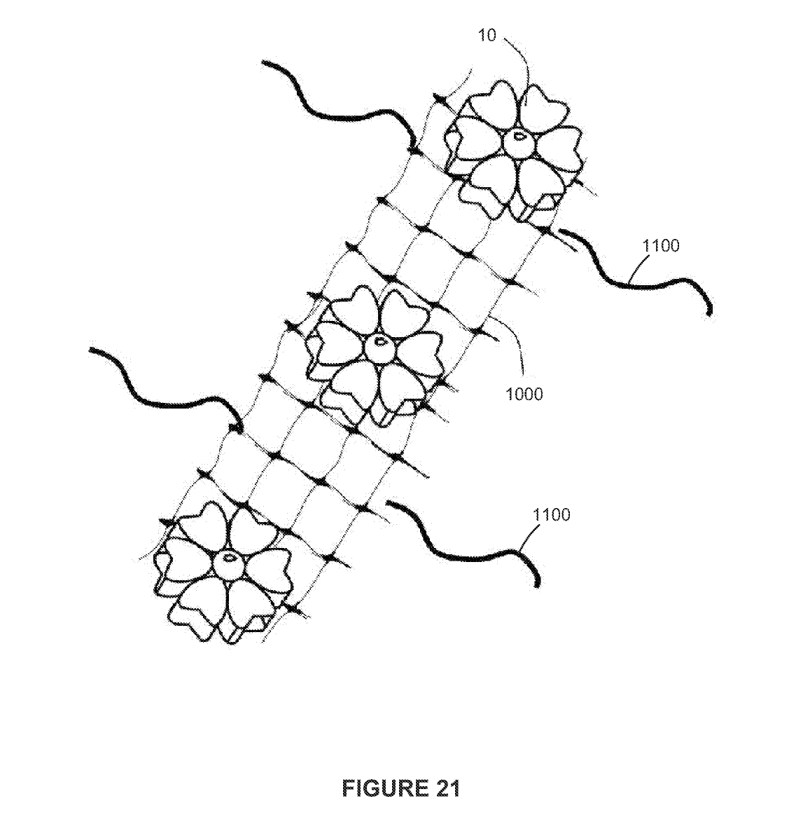

In some embodiments, a plurality of deterrent sacks may be attached to a “strip” (or “belt”) of netting. FIG. 21 shows a plurality of pest deterrent devices 10 attached to a strip of netting 1000. Netting strips may be provided with one or more straps 1100, which may be useful when securing such strips to a tree, fence, deck rail, etc.

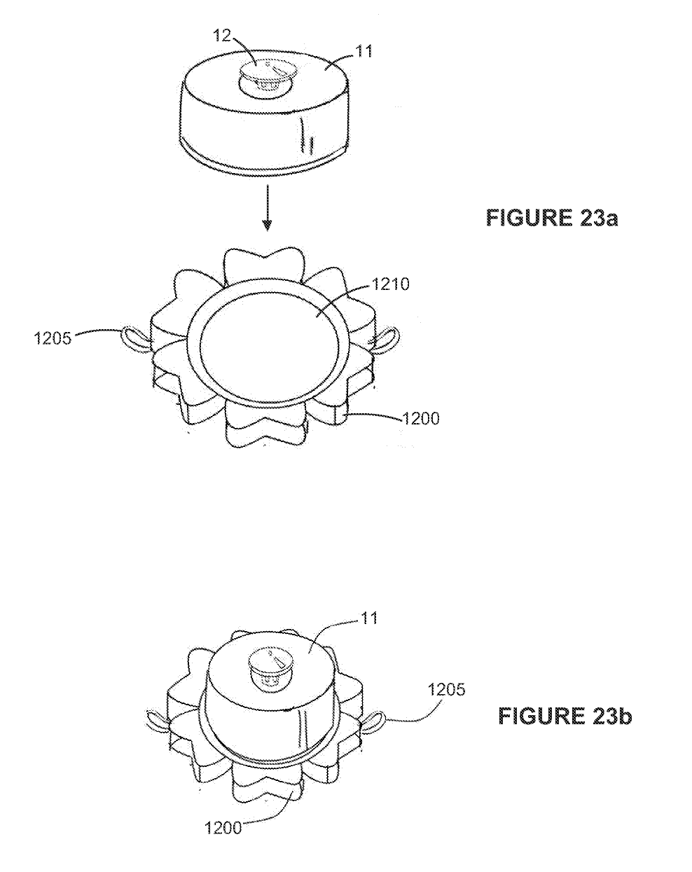

As previously discussed, pest deterrent devices may be designed to be aesthetically appealing. In some embodiments, somewhat “generic” deterrent sacks may be placed on or attached to decorative supports. For example, FIGS. 23a-b show a pest deterrent device 10 resting on a receiving area 1210 of a decorative base 1200. Decorative base 1200 also has one or more attachment loops 1205 for hanging or otherwise securing the decorative base 1200 to another object.

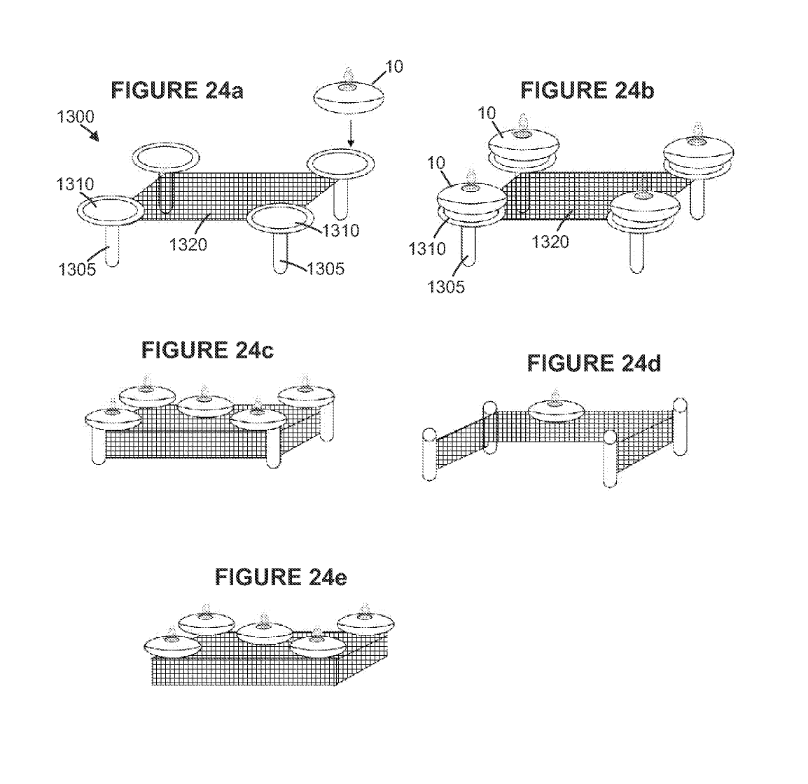

FIGS. 24a-e show a number of non-limiting examples of a raised net structure upon which one or more pest deterrent devices may be placed. The use of raised net structures in conjunction with pest deterrent devices may be particularly useful in deterring raccoons or other pests from using a particular area as a latrine. FIG. 24a shows a raised net 1320 suspended between net support members 1305. In this example, each net support member 1305 has a top surface 1310 adapted to receive and support a deterrent sack 10. FIG. 24b shows the raised net of FIG. 24a supporting a plurality of deterrent sacks 10. FIG. 24c shows an embodiment without top surfaces 1310 supporting a plurality of deterrent sacks 10. FIG. 24d shows the net structure of FIG. 24c supporting a single deterrent sack 10. FIG. 24e shows a variant embodiment with thinner net support members.

As well as providing a convenient way to deploy a plurality of pest deterrent devices over a larger area, a raised net structure may provide an additional deterrence effect, as a pest (e.g. a raccoon or other animal) may be reluctant to tamper and/or step on the raised net structure. In some embodiments, one or more raised net structures may be used without pest deterrent devices (e.g. without supporting pest deterrent sacks 10).

As discussed above, pest deterrent devices may be placed in net bags to discourage children from playing with them, as illustrated in FIGS. 25a-d.

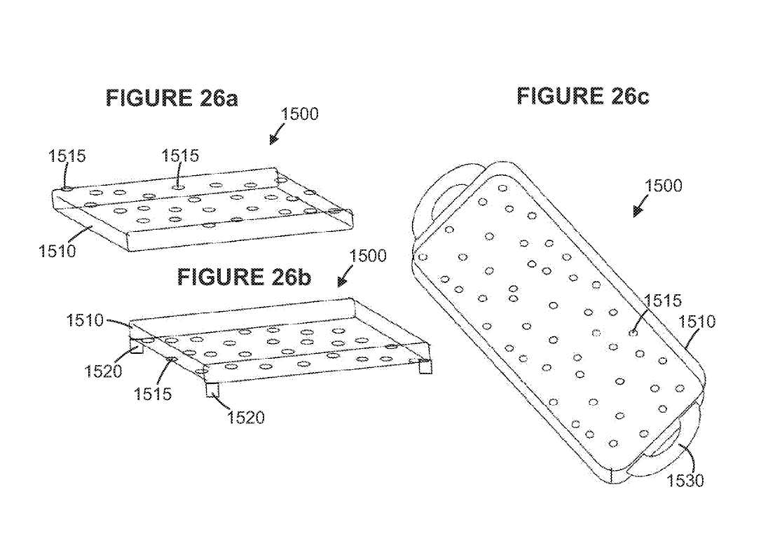

FIG. 26a shows a pest deterrent device 1500 comprising a rigid rectangular housing 1510 having a plurality of outlet ports 1515 on its upper face. FIG. 26b shows a variant pest deterrent device 1500 in which a plurality of support legs 1520 are provided to support the housing 1510 above a surface, and with a plurality of outlet ports 1515 located on a lower face of the housing 1510. FIG. 26c shows another variant pest deterrent device 1500, where housing 1510 has rounded corners, and where one or more handles 1530 are provided to allow for easy relocation of the pest deterrent device 1500.

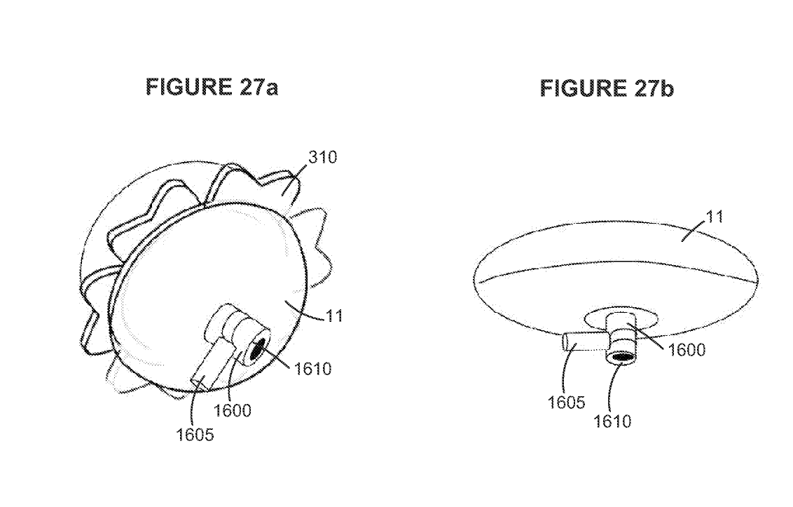

FIGS. 27a-b show another possible closure member 1600. Closure handle 1605 can be rotated to an open position permitting fluid communication between the interior of the housing 11 and the outer surface via outlet port 1610, and to a closed position where fluid communication between the interior and exterior of the housing 11 is not permitted. In the example shown in FIG. 27b, the outlet port is located on the underside of the housing 11. Such an arrangement may be useful when the housing is suspended above a surface by a support structure (e.g. holder 140 shown in FIG. 12a), allowing a slow drip of a liquid volatile deterrent agent to be released.

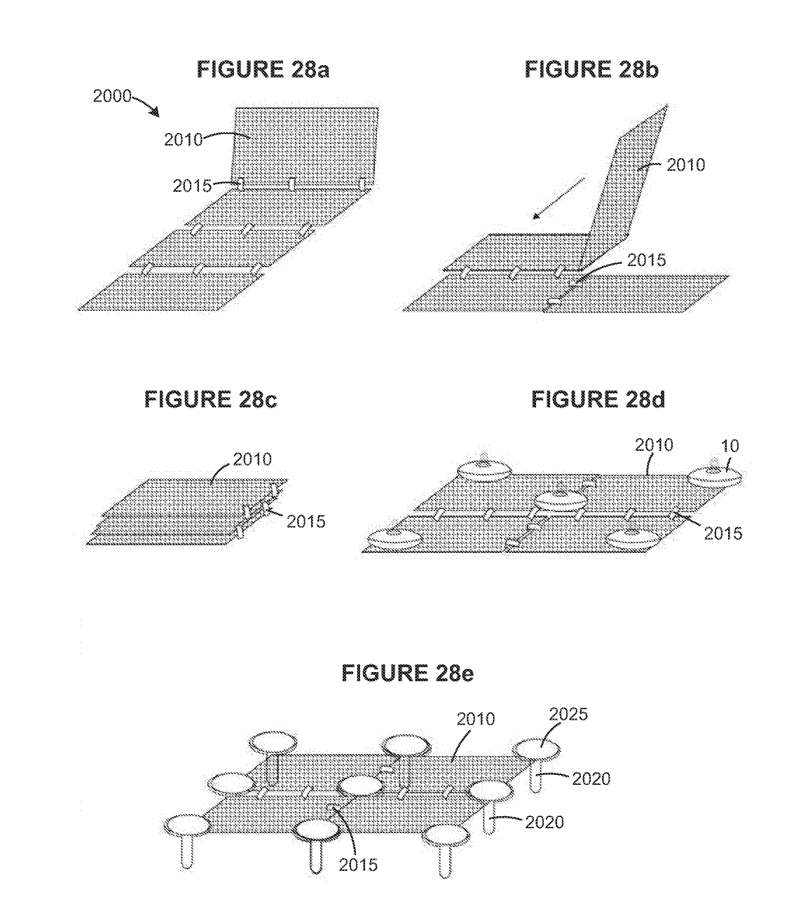

When handling nets—such as the netting and/or raised net structures described above—twisting and/or tangling of the netting may often be an issue. FIGS. 28a-e show various non-limiting examples of a foldable net for supporting one or more pest deterrent devices. Foldable net 2000 comprises a plurality of net panels 2010 connected by a plurality of net panel connectors 2015. The shape and size of the each net panel 2010 can vary. Each net panel 2010 may be made of a flexible netting, a semi-rigid netting, or a rigid netting. As can be seen in FIGS. 28a and 28b, the net panels may be arranged and connected in a variety of ways, and may be foldable into a single stack of net panels, as shown in FIG. 28c. The ability to easily fold the net panels may reduce the chance that the netting will become tangled or twisted when setting up, shifting, or packing up the netting, for example when transporting the foldable net to another location.

As shown in FIG. 28d, one or more pest deterrent sacks 10 may be supported on a foldable net 2000. The deterrent sacks can optionally be attached or unattached to the net panels. The net can be placed in a variety of areas; around trees, on decks, grassy areas, hung around tree trunks, branches etc. Alternatively, as shown in FIG. 28e, foldable net 2000 may be provided with one or more net support members 2020, which may each have a top surface 2025 adapted to receive and support a deterrent sack 10.

As discussed above with respect to FIGS. 24a-e, a raised net structure comprising a plurality of foldable net panels may provide an additional deterrence effect, as a pest (e.g. a raccoon or other animal) may be reluctant to tamper and/or step on the raised net structure. In some embodiments, one or more raised foldable net structures may be used without pest deterrent devices (e.g. without supporting pest deterrent sacks 10).

In addition to deterring pests based on odour (i.e. the release of a pest deterrent gas), it is believed that at least some embodiments of the deterrent sacks may also provide a visual deterrence. Without being limited by theory, it is thought that transparent (or relatively translucent) objects, such as transparent (or relatively translucent) deterrent sacks, may act as a visual deterrent to raccoons and/or other pests.

In addition to deterring pests based on odour (i.e. the release of a pest deterrent gas), it is believed that at least some embodiments of the deterrent sacks may also provide a tactile deterrence. Without being limited by theory, it is thought that animals will shy away from handling soft (i.e. relatively flexible) objects, and therefore deterrent sacks having a flexible housing may act as a tactile deterrent to raccoons and/or other pests.

The pest deterrent devices disclosed herein may be provided in any suitable size. For example, a pest deterrent sack may be about 10 to 30 cm across, optionally about 15 to 20 cm across. In some embodiments, for example the sealed deterrent sacks shown in FIGS. 13a-d, each sack may be about 3 to 15 cm across, optionally about 5 to 10 cm across.

In some embodiments, pest deterrent devices provided with an outlet port or other means to access the interior of the housing (e.g. two-piece devices described in relation to FIGS. 18a-c) may be refillable by a user (e.g. at home) to replace or replenish the volatile deterrent agent. Alternatively, the pest deterrent devices may be filled with a volatile deterrent agent in an automated manufacturing process (e.g. similar to bagged milk, drink and medical liquids) at a factory, and sold in a ready-to-use condition. Of course, fully sealed pest deterrent sacks will be sold pre-filled.

While the above description provides examples of one or more processes or apparatuses, it will be appreciated that other processes or apparatuses may be within the scope of the accompanying claims.

1. A pest deterrent device comprising:
a) a housing;
b) a volatile deterrent agent in the housing, the volatile deterrent agent producing a pest deterrent gas;
c) at least one outlet port in the housing for exit of the pest deterrent gas;
d) a closure member for selectively opening and closing the at least one outlet port; and
e) a support coupled to the housing and providing structural rigidity to the housing.

2. The pest deterrent device of claim 1, wherein the housing comprises a flexible sack.

3. The pest deterrent device of claim 1, wherein the housing comprises a plastic sack.

4. The pest deterrent device of claim 3, wherein the plastic sack is soft and flexible.

5. The pest deterrent device of claim 1, wherein the volatile deterrent agent comprises at least one of ammonia, urine, and pepper.

6. The pest deterrent device of claim 1, wherein the volatile deterrent agent is a solid.

7. The pest deterrent device of claim 1, wherein the closure member comprises at least one of a flip-cap assembly and a twist-cap assembly.

8. The pest deterrent device of claim 1, further comprising a blocking member inhibiting liquid from entering the outlet port.

9. The pest deterrent device of claim 1, wherein at least a portion of the support is internal to the housing.

10. The pest deterrent device of claim 9, wherein:
a) the housing comprises an upper surface and a lower surface;
b) the outlet port is in the upper surface; and
c) the support comprises a rigid tube extending between the outlet port and the lower surface, the rigid tube comprising a first opening in communication with the outlet port and a second opening in communication with an interior of the housing.

11. The pest deterrent device of claim 1, wherein the support comprises a sponge within the housing.

12. A pest deterrent assembly comprising:
a) a support frame; and
b) a plurality of pest deterrent devices mounted to the support frame at a plurality of spaced apart positions, each pest deterrent device comprising: a housing, and a volatile deterrent agent in the housing, the volatile deterrent agent producing a pest deterrent gas, the housing configured to permit the pest deterrent gas to escape therefrom.

13. The pest deterrent assembly of claim 12, wherein the support frame comprises at least one of a rope and a net.

14. The pest deterrent assembly of claim 12, wherein each housing comprises a plastic sack.

15. The pest deterrent assembly of claim 12, wherein at least one of the pest deterrent devices further comprises an outlet port in its housing for exit of the pest deterrent gas, a closure member for selectively opening and closing the outlet port; and a support connected to the housing and providing structural rigidity to the housing.

16. The pest deterrent assembly of claim 12, wherein in at least one of the pest deterrent devices, its housing is fabricated from a material that is permeable to the pest deterrent gas, and impermeable to the volatile deterrent agent.

17. A pest deterrent device comprising a generally sealed housing containing a volatile deterrent agent, the volatile deterrent agent producing a pest deterrent gas, the housing permeable to the pest deterrent gas and impermeable to the volatile deterrent agent.

18. The pest deterrent device of claim 17, wherein the housing comprises a sealed plastic sack.

19. The pest deterrent device of claim 17, wherein the volatile deterrent agent comprises at least one of ammonia and urine.

20. A method for deterring pests from an area comprising:
a) providing a plurality of pest deterrent devices in the area, each pest deterrent device comprising a housing containing a volatile deterrent agent, the volatile deterrent agent producing a pest deterrent gas; and
b) opening a closure member of each pest deterrent device to release the volatile deterrent agent.
